(19) United States
(12) Patent Application Publication
(10) Pub. No.: US 2010/0193993 A1
(43) Pub. Date: Aug. 5, 2010

(54) METHOD OF MAKING A SECONDARY IMPRINT ON AN IMPRINTED POLYMER

(75) Inventors: Hong Yee Low, Singapore (SG); Karen Chong, Singapore (SG)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Agency for Science, Technology and Research, Centros (SG)

(21) Appl. No.: 12/666,048

(22) PCT Filed: Jun. 23, 2008
(86) PCT No.: PCT/SG08/00221

§ 371 Date: Feb. 17, 2010

Related U.S. Application Data
(60) Provisional application No. 60/946,443, filed on Jun. 27, 2007.

(51) Int. Cl. B29C 59/02

(52) U.S. Cl. 264/293

(57) ABSTRACT

There is disclosed a method of making an imprint on a polymer structure comprising the step of pressing a mold having a defined surface pattern against the surface of a primary imprint of a polymer structure to form a secondary imprint thereon.

### TECHNICAL FIELD

The present invention generally relates to a method of making a secondary imprint on an imprinted polymer.

### BACKGROUND

With the constant miniaturization of existing electronic devices, there is an increasing need for methods and equipment that can produce electrical components that are positioned as close together. According to empirical observations, such as Moore's Law, the number of transistors on an integrated circuit doubles approximately every two years. Therefore, nanopatterning techniques play pivotal roles in the evolution of microelectronic and nanoelectronic devices, such as integrated circuits (ICs), microelectromechanical systems (MEMS)/nanoelectromechanical systems (NEMS), optical components and light emitting diodes (LEDs). Existing nanopatterning techniques include photolithography, e-beam lithography and nanoimprint lithography (NIL).

Conventional photolithography techniques employ light, usually in the form of ultraviolet (UV) radiation, to selectively radiate a predefined portion of a light-sensitive chemical known as photoresist, which is deposited on a substrate surface. The step of selective radiation is usually accomplished through the use of a photomask to shield/expose respective regions of the photoresist from/to the UV radiation. This process is usually followed by the partial removal of the photoresist layer and a plethora of deposition processes, such as chemical vapor deposition (CVD) or physical vapor deposition (PVD). Accordingly, photolithography affords precise control over the shape and size of the pattern thus created on the substrate and the pattern can be created over the entire substrate in a single process.

A problem associated with photolithography is that the resolution of the pattern formed is unable to go below the 100 nm range. This is largely due to the diffraction effects of light, which in turn affect the precision in which the photoresist is radiated by the light. Consequently, this results in a resolution limit achievable through conventional photolithography. As diffraction is an inherent physical property of light, it can be said that the resolution limit of photolithography is considerably difficult to improve upon. Furthermore, the photomask used in the process is both expensive and time consuming to produce, thereby, increasing the capital costs associated with photolithography.

Electron beam (e-beam) lithography is a patterning technique involving the scanning of a beam of electrons in a patterned manner across a substrate covered with a resist. The purpose of this is to create very small structures in the resist that can subsequently be transferred into another material for use in other applications, such as in microelectronics.

A problem associated with e-beam lithography is that it is a very slow process, because the patterning process is carried out on a pixel-by-pixel basis. Consequently, throughput becomes a serious limitation, especially when writing dense patterns over large area substrates. Furthermore, the equipment required for e-beam lithography is expensive and complex to operate, thus requiring an enormous deal of maintenance.

A further problem associated with e-beam lithography is the potential for the occurrence of data-related defects. As can be reasonably expected, larger data files (larger patterns) are more susceptible to data-related defects such as blanking or deflection errors, caused by discrepancies in the data input to the optical control hardware. Other defects such as sample charging, backscattering calculation errors, dose errors, fogging, outgassing and contamination may also occur. As mentioned, the long “write time” associated with e-beam lithography makes it such that random defects, such as those listed above, are more likely to occur. These problems will be particularly significant when there is a need to pattern a high volume throughput of large surface area substrates in a small time period.

NIL is another known nanopatterning technique having the advantage of being of relatively low cost, high throughput and high resolution. A mold is typically used to create patterns on the imprint resist via thermomechanical deformation. The resist is then subsequently removed via etching processes to reveal a pattern on a substrate. The imprint resist is typically a monomer or polymer formulation that is cured by heat or UV light during imprinting. Adhesion between the resist and the mold is controlled to ensure ease of detachment after the deformation process.

A problem associated with existing NIL is the need to manufacture high-resolution molds for imprinting on the resist. As resolution of the molds increases, the costs associated with the use of the NIL technique also increases as the mold production forms a considerable proportion of the capital costs involved with NIL.

Therefore, there is a need for an improved method to imprint higher resolution patterns on a substrate surface while avoiding or at least ameliorating the problems as described above.

There is also a need for an improved method to imprint higher resolution patterns on a substrate surface by employing the NIL technique but yet at the same time, minimizing the costs of template fabrication.

### SUMMARY

According to a first aspect there is provided a method of making an imprint on a polymer structure comprising the step of pressing a mold having a defined surface pattern against the surface of a primary imprint of a polymer structure to form a secondary imprint thereon.

In one embodiment, there is provided a method of making a nano-sized or micro-sized imprint on a polymer structure comprising the step of pressing a mold having a defined surface pattern that is nano-sized or micro-sized against the surface of a micro-sized or nano-sized primary imprint of a polymer structure to form a nano-sized or micro-sized secondary imprint thereon. In one embodiment, the secondary imprint has a nano-size dimension while the primary imprint has a micro-size dimension.

In one embodiment, at least one of the primary and secondary imprints are in the form of a generally longitudinal channel. Advantageously, the channel width of the primary imprint can be reduced to a range of about to about 13 folds after said pressing step. In one embodiment, the primary polymer imprint can be made nano-sized without the use of a mold having an equivalent nano-sized imprint. Therefore, a significant reduction of the channel width of the primary imprint can be achieved using the process disclosed herein.

According to a second aspect there is provided a method of making an imprint on a polymer structure comprising the steps of:

(a) pressing a mold having a defined surface pattern against the surface of the polymer structure to form a primary imprint thereon; and

(b) pressing another mold having a defined surface pattern against the surface of the primary imprint of the polymer structure to form a secondary imprint thereon.

In one embodiment, there is provided a method of making a nano-sized imprint on a polymer structure, the method comprising the steps of:

(a) pressing a mold having a defined micro-sized channel pattern against the surface of the polymer structure to form a primary micro-sized channel imprint thereon; and

(b) pressing another mold having a defined nano-sized channel pattern against the surface of the micro-sized channel imprint to form a secondary nano-sized channel imprint thereon and wherein the width of the channels reduces to the nano-size range.

According to a third aspect, there is provided an imprinted polymer structure, the imprinted polymer structure made in a method comprising the step of pressing a mold having a defined surface pattern against the surface of a primary imprint of a polymer structure to form a secondary imprint thereon.

In one embodiment, there is provided a nano-sized or micro-sized imprinted polymer structure, the nano-sized or micro-sized imprinted polymer structure made in a method comprising the step of pressing a mold having a defined surface pattern against the surface of a micro-sized or nano-sized primary imprint of a polymer structure to form a nano-sized or micro-sized secondary imprint thereon.

According to a fourth aspect, there is provided the use of the imprinted polymer structure as defined above in nanoelectronics.

### DEFINITIONS

The following words and terms used herein shall have the meaning indicated:

The term “nano-size” refers to a structure having a thickness dimension in the nano-sized range of about 1 nm to less than about 1 micron.

The term “micro-sized” refers to a structure having a thickness dimension in the micro-sized range of about 1 micron to about 10 micron.

The term “channel” used in the context of the specification generally refers to a region of space disposed between a pair of projections extending from the base of the polymer structure, each projection having a length dimension extending along a longitudinal axis, a height dimension and a width dimension normal to the longitudinal axis. The term “channel width” used herein refers to the width of the channel normal to the longitudinal axis of the polymer structure. Typically, there are plural channels provided on the polymer.

The term “photoresist” indicates a photosensitive material commonly used in a semiconductor fabrication process. In detail, the photoresist indicates a material exhibiting a change in physical properties, such as solubility change in a specific solvent, i.e., solubilization or insolubilization, due to an instant change of its molecular structure induced by irradiation.

The term “positive photoresist” as used herein refers to any type of polymer material that becomes soluble in a corresponding developer upon exposure to light, typically ultra-violet light.

The term “negative photoresist” as used herein refers to any type of polymer material that becomes insoluble in a corresponding developer upon exposure to light, typically ultra-violet light.

The term “developer” as used herein typically refers to an organic or aqueous medium, which is usually basic in nature, employed as a solvent for various types of photoresists polymers.

The term “mold” disclosed herein generally refers to a mold structure or a master mold that is used for shaping or fabrication of a specific article or product.

The term “pressing” in the context of this specification may refer to one body pressing against another body, or vice versa, or both bodies approaching each other at the same time to impart a compressive force. For example, the term “pressing A against B” would not only cover body A pressing against body B but would also cover body B pressing against body A and both bodies A and B pressing against each other.

The term “polymer” as used herein denotes a molecule having two or more units derived from the same monomer component, so that the “polymer” incorporates molecules derived from different monomer components to form copolymers, terpolymers, multi-component polymers, graft-co-polymers, block-co-polymers, and the like.

The term “surface pattern” as used herein generally refers to an outer peripheral surface of any structure disclosed herein.

The term “spin-coating”, or grammatical variations thereof as used herein generally refers to a process wherein a polymer solution is dispersed on a surface (e.g., a mold or substrate) and the surface is rapidly spun centrifugally forcing the solution to spread out and forming a thin layer of de-solvated polymer in the process.

The term “substantially” does not exclude “completely” e.g. mold A which is placed “substantially parallel” to mold B may be completely parallel to the longitudinal axis of mold B. Where necessary, the term “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

Exemplary, non-limiting embodiments of a method of making an imprint on a polymer structure will now be disclosed.

In one embodiment, there is provided a method of making a nano-sized or micro-sized imprint on a polymer structure comprising the step of pressing a mold having a defined surface pattern against the surface of a micro-sized or nano-sized primary imprint of a polymer structure to form a nano-sized or micro-sized secondary imprint thereon.

In another embodiment, the secondary imprint is of a smaller dimension relative to said primary imprint. In one embodiment, the primary imprint can be nano-sized or micro-sized. Advantageously, the primary polymer imprint can be made nano-sized without the use of a mold having an equivalent nano-sized imprint. This effectively reduces the costs involved in nano imprint lithography as molds having nano-sized imprints equivalent to the imprinted polymer are generally more expensive.

The primary imprint of the polymer structure may be comprised of a plurality of generally longitudinal channels imprinted on the surface of the imprinted polymer structure. Likewise, the secondary imprint may be comprised of a plurality of generally longitudinal channels imprinted on the surface of the primary polymer structure.

In another, embodiment, there is provided a method of making an imprint on a polymer structure wherein the pressing step can reduce the width of the channel of said primary imprint.

In one embodiment, the channel width of the primary imprint can be reduced in the range selected from the group consisting of about 2 to about 13 fold; about 2 to about 10 fold; about 2 to about 8 fold; and about 2 to about 5 fold.

Advantageously, the reduced channel width of the primary imprint can be used to deposit nano-metal lines or wire.

In one embodiment, the channel width of said primary imprint can be reduced from the micro-size range to the nano-size range after said width has been reduced by said pressing step. In one embodiment, the channel width of said primary imprint can be reduced from a size range of more than about 2 micron; more than about 1.5 micron; more than about 1 micron; and more than about 0.5 micron before said pressing step. In another embodiment, the channel width of said primary imprint can be reduced to a size range of less than about 800 nm; less than about 750 nm less than about 700 nm less than about 650 nm; less than about 500 nm; less than about 450 nm; less than about 400 nm; less than about 350 nm; and less than about 150 nm after said pressing step.

In a particular embodiment, the channel width of said primary imprint can be reduced from a size range of more than about 1 micron to a size range of less than about 800 nm after said pressing step. More preferably, the channel width of said primary imprint can be reduced from a size range of more than about 1 micron to a size range of less than about 500 nm after said pressing step.

In one embodiment, the polymer structure may be comprised of a photoresist. In another embodiment, the photoresist can be selected from the group consisting of SU-8, diazonaphtoquinone-novolac resin (DNA/NR) BF410 (Tokyo Oka, Japan) and combinations thereof.

In one embodiment, the polymer disclosed herein may comprise a thermoplastic polymer. Exemplary thermoplastic polymers include, but are not limited to, polymers selected from the group consisting of acrylonitrile butadiene styrene (ABS), acrylic, celluloid, ethylene-vinyl acetate (EVA), ethylene vinyl alcohol (EVAL), fluoroplastics, liquid crystal polymer (LCP), polyacetal (POM or acetal), polyacrylonitrile (PAN or Acrylonitrile), polyamide-imide (PAI), polyaryletherketone (PAEK or Ketone), polybutadiene (PBD), polycaprolactone (PCL), polychlorotrifluoroethylene (PCTFE), polyethylene terephthalate (PET), polycyclohexylene dimethylene terephthalate (PCT), polyhydroxyalkanoates (PHAs), polyketone (PK), polyester, polyethylene (PE), polyetheretherketone (PEEK), polyetherimide (PEI), polyethersulfone (PES), polyethylenechlorinates (PEC), polylactic acid (PLA), polymethylpentene (PMP), polyphenylene oxide (PPO), polyphenylene sulfide (PPS), polyphthalamide (PPA), polysulfone (PSU), polyvinylidene chloride (PVDC), spectralon, polymethyl methacrylate (PMMA), polycarbonate (PC), polyvinylacetate (PVAc), Biaxially Oriented Poly Propylene (BOPP), polystyrene (PS), polypropylene, High-Density Polyethylene (HDPE), poly(amides), polyacryl, poly(butylene), poly(pentadiene), polyvinyl chloride, polyethylene terephthalate, polybutylene terephthalate, polysulfone, polyimide, cellulose, cellulose acetate, ethylene-propylene copolymer, ethylene-butene-propylene terpolymer, polyoxazoline, polyethylene oxide, polypropylene oxide, polyvinylpyrrolidone, and combinations thereof.

In one particular embodiment, the thermoplastic polymer may comprise polystyrene (PS).

In one embodiment, there is provided a method of making an imprint on a polymer structure wherein the pressing step can be performed at a temperature below the glass transition temperature of the polymer structure, to form the secondary imprint thereon. In another embodiment, the pressing step can be performed at a temperature in the range selected from the group consisting of about 20° C. to about 100° C.; about 20° C. to about 85° C.; about 20° C. to about 65° C.; about 20° C. to about 45° C.; about 30° C. to about 100° C.; about 45° C. to about 100° C.; about 65° C. to about 100° C. and about 85° C. to about 100° C. In one particular embodiment, the temperature condition during the pressing step is about 40° C. to about 65° C.

In one embodiment, there is provided a method of making an imprint on a polymer structure, further comprising, prior to the pressing step, the step of forming said primary imprint by pressing a mold having a defined surface pattern against the surface of the polymer structure, to form the primary imprint thereon.

In one embodiment, the pressing step to form the primary imprint on the polymer structure may be undertaken at a temperature in the range selected from the group consisting of about 50° C. to about 180° C.; about 50° C. to about 150° C.; about 50° C. to about 100° C.; about 50° C. to about 80° C.; about 100° C. to about 180° C.; and about 150° C. to about 180° C. In one particular embodiment, the temperature condition during the pressing step is about 90° C. to about 140° C.

In one embodiment, there is provided a method of making an imprint on a polymer structure wherein the pressure condition during the pressing steps may be in the range selected from the group consisting of about 2 MPa to about 10 MPa; about 2 MPa to about 8 MPa; and about 2 MPa to about 5 MPa. In one particular embodiment, the pressure condition during the pressing steps is about 4 MPa to about 6 MPa.

In one embodiment, there is provided a method of making an imprint on a polymer structure wherein the time condition during the pressing steps may be in the range selected from the group consisting of about 1 minute to about 15 minutes; about 1 minute to about 10 minutes; about 1 minute to about 5 minutes; about 5 minutes to about 15 minutes; and about 10 minutes to about 15 minutes. In one particular embodiment, the time condition during the pressing steps is about 5 minutes to about 10 minutes.

In one embodiment, there is provided a method of making an imprint on a polymer structure further comprising, after the pressing step, the step of pressing another mold having a defined surface pattern against the surface of the secondary imprint of the polymer structure, to form a tertiary imprint thereon.

Advantageously, the step of forming a tertiary imprint on the surface of the secondary imprint may result in a reduction of the channel width of the secondary imprint. Therefore, tertiary nano-sized imprints can be made without using molds of sizes equivalent to the tertiary nano-sized imprints.

In one embodiment, the primary and secondary imprints may be in the form of generally longitudinal channels, wherein the pressing step may comprise the step of orienting the mold during the pressing step such that the longitudinal axis of the primary and secondary imprints are at an alignment angle to each other in the range selected from the group consisting of about 0 degrees to about 90 degrees to each other; about 0 degrees to about 80 degrees to each other; about 0 degrees to about 65 degrees to each other; about 0 degrees to about 45 degrees to each other; about 0 degrees to about 25 degrees to each other; about 10 degrees to about 90 degrees to each other; about 20 degrees to about 90 degrees to each other; about 35 degrees to about 90 degrees to each other; about 45 degrees to about 90 degrees to each other; and about 60 degrees to about 90 degrees to each other. In one particular embodiment, the alignment angle between the longitudinal axis of the primary and secondary imprints can be about 25 degrees to about 60 degrees to each other.

In one embodiment, the mold may be oriented during the pressing step such that the longitudinal axes of the primary and secondary imprints can be substantially parallel to each other. In another embodiment, the mold may be oriented during the pressing step such that the longitudinal axes of the primary and secondary imprints are at an alignment angle to each other of about 45 degrees. In yet another embodiment, the mold may be oriented during the pressing step such that the longitudinal axes of the primary and secondary imprints can be substantially perpendicular to each other.

Advantageously, different types of imprinted polymer structures having different channel widths can be produced when the mold is oriented such that the alignment angle between the longitudinal axis of the primary and secondary imprints is about 0 degrees to 90 degrees to each other during the pressing step. Furthermore, there is a significant reduction in the channel width of the primary imprint when the longitudinal axes of the primary and secondary imprints are substantially perpendicular or at an alignment angle of 45 degrees to each other. Furthermore, there is a more significant reduction in the channel width when the longitudinal axes of the primary and secondary imprints are substantially perpendicular to each other. Therefore, the primary imprints having a reduced channel width are useful in depositing nano metal lines or wires.

The reduction in the channel width of the primary imprint may depend on a combination of factors such as the type of polymer used and the pressure applied during the pressing step. For example, different types of polymers having different thermo-mechanical properties may affect the size of the channel width during the pressing step.

The defined surface pattern of the mold to form the primary imprint and/or the mold to form the secondary imprint may be comprised of a plurality of projections extending from the base of the mold, each projection having a width dimension normal to the longitudinal axis of said mold. In one embodiment, the width dimension of the mold for forming the primary imprint on the polymer structure may be in the range selected from the group consisting of about 0.25 μm to about 10 μm; about 0.25 μm to about 4 μm; about 0.25 μm to about 2 μm; about 0.5 μm to about 10 μm; about 1.5 μm to about 10 μm; and about 4 μm to about 10 μm. In one particular embodiment, the width dimension of the mold for primary imprinting is about 0.25 μm to about 2 μm.

In one embodiment, there is provided a method of making an imprint on a polymer structure further comprising, before said pressing step, the step of spin-coating a polymer on a substrate to form the polymer structure. The substrate can be chemically inert to said polymer. In one embodiment, the substrate may be selected from the group consisting of silicon, glass, metal, metal oxide, silicon dioxide, silicon nitride, Indium Tin oxide, ceramic, sapphire, polymeric and combinations thereof.

In one embodiment, there is provided a method of making a primary imprint on a polymer structure, further comprising, after the pressing step, the step of removing the residual layer from the substrate. In one embodiment, an oxygen plasma is introduced to remove the residual layer from the substrate.

Advantageously, when the polymer with the right etch resistance is used, the channel width of the polymer imprint may expose the underneath substrate which can be etched to replicate the channel width onto the substrate. Therefore, the imprinted polymer structure can be used as a dry or wet etch mask to etch nanometer sized features into the substrate.

In one embodiment, there is provided a method of making an imprint on a polymer structure comprising the steps of:

(a) pressing a mold having a defined surface pattern against the surface of the polymer structure to form a primary imprint thereon; and

(b) pressing another mold having a defined surface pattern, against the surface of the primary imprint of the polymer structure to form a secondary imprint thereon.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 schematically illustrates a disclosed process of making a primary and secondary imprint on a polymer structure.

FIG. 2 shows scanning electron microscope (SEM) images of the polymer structure fabricated using the disclosed method.

FIG. 3 shows a graph illustrating the trend of the channel width reduction as a function of the secondary mold pattern.

FIG. 4 shows scanning electron microscope (SEM) images of the polymer structure fabricated using the disclosed method.

### DETAILED DISCLOSURE OF EXEMPLARY EMBODIMENT

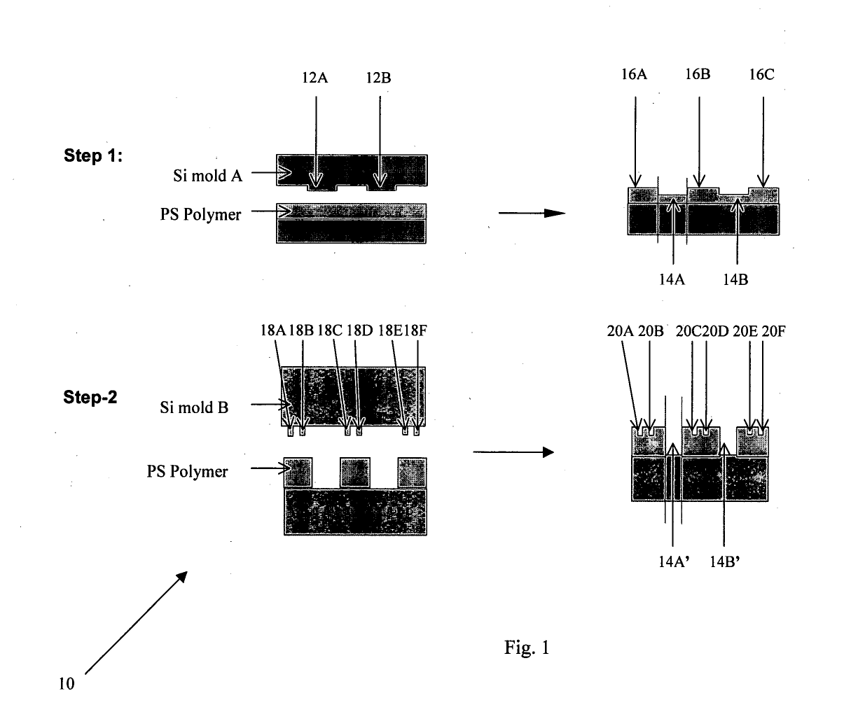

Referring to FIG. 1, there is disclosed a schematic illustration of a disclosed process 10 for forming a primary and a secondary imprint on a polymer structure.

In Step 1, a first silicon (Si) mold A having an imprinted surface pattern consisting of projections (12A, 12B), which extend along the length of the Si mold A, is aligned directly above the surface of a flat polystyrene polymer substrate (PS). Si mold A is pressed towards the surface of the PS polymer, at a temperature of 140° C., at 6 MPa for 10 minutes to form a primary imprint consisting of trench gaps (14A, 14B) and projections (16A, 16B, 16C) along the surface of the primary imprint.

The primary imprint is then exposed to reactive ion etching to remove the residual layer (not shown).

In Step 2, a second Si mold B having a defined surface pattern consisting of projections (18A, 18B, 18C, 18D, 18E, 18F) is placed directly above the surface of the primary imprint of the PS polymer. The second Si mold B is oriented such that the longitudinal axis of the Si mold B and the PS polymer are at an alignment angle of 0 degrees from each other; that is parallel to each other.

Si mold B is pressed towards the surface of the primary imprint at a temperature of 65° C., at 6 MPa for 10 minutes to form a secondary imprint consisting of trench gaps (20A, 20B, 20C, 20D, 20E, 20F) on the surface of the primary imprint. A significant reduction in the width of the trench gaps (14A, 14B) in Step 1 and the width of trench gaps (14A′, 14B′) in Step 2 can be clearly observed.

### EXAMPLES

Non-limiting examples of the invention will be further described in greater detail by reference to specific Examples, which should not be construed as in any way limiting the scope of the invention.

### Example 1

This example describes the method of mold preparation and imprinting to achieve pattern size reduction in NIL using a negative photoresist (SU-8), purchased from Micro Chem Corp, USA and polystyrene (PS), from Sigma Aldrich, Singapore.

### Mold Treatment

The molds used for the primary imprinting process were made of silicon (Si). The molds are cut into sizes of 2 cm by 2 cm using a diamond scribe. They were then cleaned by sonication in acetone and then isopropanol for 10 minutes. The molds were further treated in an oxygen plasma (80 W, 250 Torr) for ten minutes. After the oxygen treatment, the molds were then silanized with a 20 mM solution of perfluorodecyltrichlorosilane (FDTS) for half an hour in a nitrogen glovebox. The relative humidity in the glove box was kept between 10 to 15%. The molds were then rinsed with heptane and isopropanol respectively. The molds were then soft-baked for one hour in an oven at 95° C. to remove any residual solvent.

Prior to imprinting, all the molds used were cleaned again by sonication with acetone and isopropanol for 10 minutes and then dried with nitrogen before use.

### Film Preparation

All resist (SU-8) films were prepared by spin coating the resist on either well-cleaned Si wafers or Indium-Tin-Oxide (ITO) substrates. The substrates were treated in oxygen plasma (80 W, 250 Torr) for 10 minutes. SU-8 2002 was originally formulated in cyclopentanone and was used as received by the supplier. The coating conditions used were formulated to give a resist film 15, thickness of 2 μm. Approximately 1 ml of resist was used for every 1 cm² area of substrate surface. The spin cycle was set at 3000 rpm for 30 seconds. After the resist had been applied to the substrate, the resist-coated substrate (sample) was then soft baked at 65° C. for 5 minutes and then at 95° C. for 5 minutes to evaporate the solvent and to increase the density of the resist film. The samples were baked on a digital level hotplate.

Polystyrene (PS) films were prepared by spin coating a 12% PS solution (45 k) on well-cleaned silicon wafers. The coating conditions used were formulated to give a film thickness of between 1.8 μm to 2 μm. Approximately 1 ml of 12% PS was used per 1 cm² area of substrate surface. The spin cycle used was set at 500 rpm for 30 seconds to obtain a minimal residual layer of 188 nm on the PS sample. After spin-coating, the sample was then soft baked at 65° C. for 5 minutes to evaporate the solvent. The samples were baked on a digital level hotplate.

### Imprinting Conditions

Imprinting is carried out on an Obducat imprinter. The mold was placed on top of the sample and loaded into the imprinter. The resist was imprinted at 90° C. and 60 bars (absolute) for 600 seconds while PS was imprinted at 140° C. and 40 bars (absolute) for 600 seconds. The primary imprint was carried out with a 2 μm grating mold with a duty cycle of 1:1 and the secondary mold used was a 250 nm grating mold, also with duty cycle of 1:1.

After the initial step of primary imprinting was completed, an oxygen plasma (RIE Trion) was used to etch away the residual layer (the resist/PS region that had been thermomechanically deformed) before a secondary imprint was carried out.

Therefore, it was important to minimize the residual layer of the primary imprint to avoid over-etching the initial primary resist structure. Furthermore, the step of removing the residual layer allows lateral movement of the projections of the primary polymer so that the channel width of the primary polymer can be effectively reduced during the secondary imprinting process.

An optimal etching time of 10 seconds was used to etch away the residual layer. A series of etching durations associated with the thickness of the residual layer is shown in Table 1.

TABLE 1
Optimization of residual layer in PS imprint through
spin condition, the corresponding residual layer
thickness and required etching time are shown.

| | | | |
|---|---|---|---|
| | | Thickness of PS | Etching time with |
| Product | Spin speed | residual layer | etch rate of 25 |
| name | (rpm) | (nm) | nms⁻¹ (s) |

| | | | | |
|---|---|---|---|---|
| PS | 2000 | <100 | nm | <4 |
| | 1000 | 125 | nm | 5-6 |
| | 500 | 188 | nm | 8-10 |

It can be shown in Table 1 that the duration for etching increases as the spin speed decreases.

After the primary imprinting and residual layer etching, a secondary imprint process was carried out at a reduced temperature (below glass transition temperature T_{g}) of 40° C. at 60 bars for 600 seconds for the resist and at 65° C. at 40 bars for 600 seconds for the PS.

For resist samples, after the residual removal, the samples were then exposed to UV light in the imprinter for 10 seconds, resulting in crosslinking within the resist structure. The samples were then baked in a convection oven at 180° C. for 2.5 hours. The temperature was reduced slowly to allow the samples to cool gradually. This was to prevent thermal stresses from occurring in the sample. The samples were then demolded to separate the mold from the substrate. The PS samples did not require any exposure or post baking treatment, and were simply demolded to separate the mold from the substrate.

### Example 2

The samples used in the current example were prepared using the same protocol as described in Example 1. The imprinting protocol was also the same as described in Example 1. This example further illustrates the use of a secondary imprint to improve the pattern resolution on a photoresist (SU-8) coating.

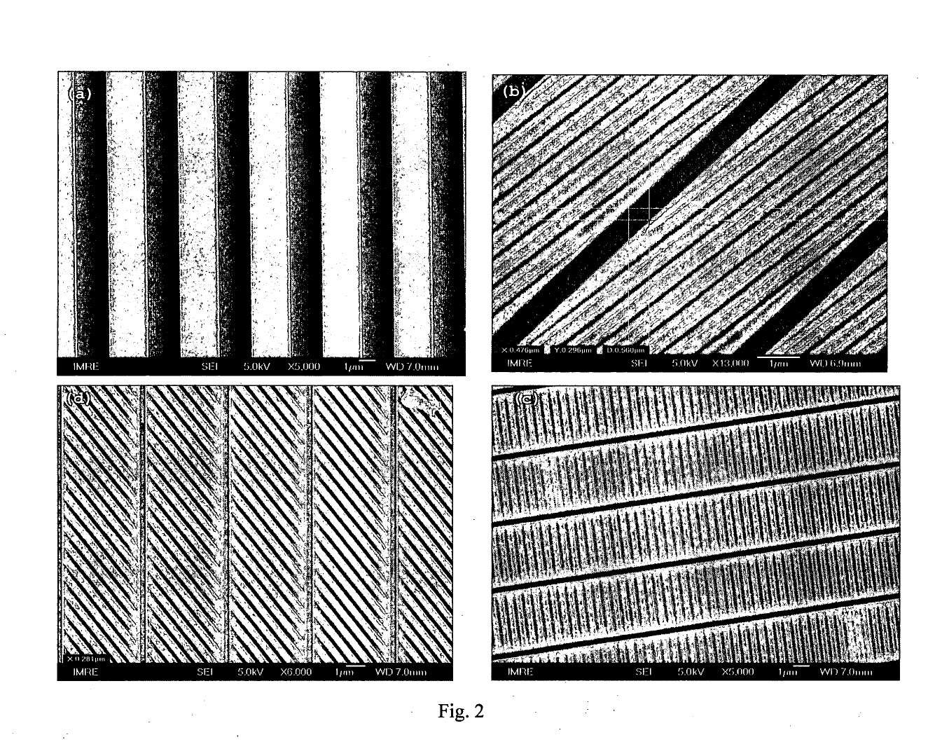

FIG. 2(a) shows an SEM image, having a magnification of 5000×, of the primary resist structure after the primary imprinting by the grating mold. As shown, a grating pattern having a trench gap width of 2 μm was imprinted on a negative photoresist (SU-8) layer deposited on a silicon substrate. The trench gap width of 2 μm was congruent with the resolution pattern of the grating mold used. The primary resist structure has a pitch of 4 μm.

FIG. 2(b) shows an SEM image, having a magnification of 13,000×, illustrating the secondary grating pattern obtained when a 250 nm grating mold (secondary mold) was further imprinted on the surface of the primary imprint obtained from FIG. 2(a). The alignment of the longitudinal axis of the channels of the secondary mold were placed almost parallel to the longitudinal axis of the channels of the primary imprint, resulting in parallel trenches running along the primary resist structure. A trench gap width reduction from 2 μm to 550 nm (reduced by a factor of 3.6) can be clearly observed in the primary imprint.

FIG. 2(c) shows a SEM image, having a magnification of 5,000×, illustrating the secondary grating pattern obtained when a 250 nm grating mold (secondary mold) was further imprinted on the surface of the primary imprint obtained from FIG. 2(a). The longitudinal axis of the channels of the secondary mold was placed perpendicular to the longitudinal axis of the primary imprint. A trench gap width reduction from 2 μm to 300 nm can be clearly observed in the primary imprint.

FIG. 2(d) shows a SEM image, having a magnification of 6,000×, illustrating the secondary grating pattern obtained when a 250 nm grating mold (secondary mold) was further imprinted on the surface of the primary imprint obtained from FIG. 2(a). The secondary mold was placed at an angle of 45 degrees to the longitudinal axis of the primary imprint. A trench width gap reduction from 2 μm to 281 nm can be clearly observed in the primary imprint.

TABLE 2
Summary table of the reduction in trench width
fabricated by nanoimprint lithography (NIL) for
a resist polymer layer.

| | | | | | Percentage/ |
|---|---|---|---|---|---|
| | | | Gap | | Fold |
| Primary | Secondary | | size(nm) | | reduction |
| Imprint | Imprint | Polymer | after | | in gap |
| Mold | Mold | Material | reduction | Alignment | size |
| 2 μm | 250 nm | SU-8 | 550 | Parallel | 72.5 |
| gratings | gratings | | | | (~3.6 fold |
| | | | | | reduction) |
| 2 μm | 250 nm | SU-8 | 300 | 90° | 85.0 |
| gratings | gratings | | | | (~6.6 fold |
| | | | | | reduction) |
| 2 μm | 250 nm | SU-8 | 281 | 45° | 85.9 |
| gratings | gratings | | | | (~7 fold |
| | | | | | reduction) |

Table 2 provides a summary of trench width reduction for a resist primary structure, obtained through a combination of primary and secondary mold imprinting in various alignments. A significant reduction in trench width of the primary imprint can be observed when the 250 nm secondary imprint mold is imprinted at an angle of 45 degrees or 90 degrees to the longitudinal axis of the primary imprint.

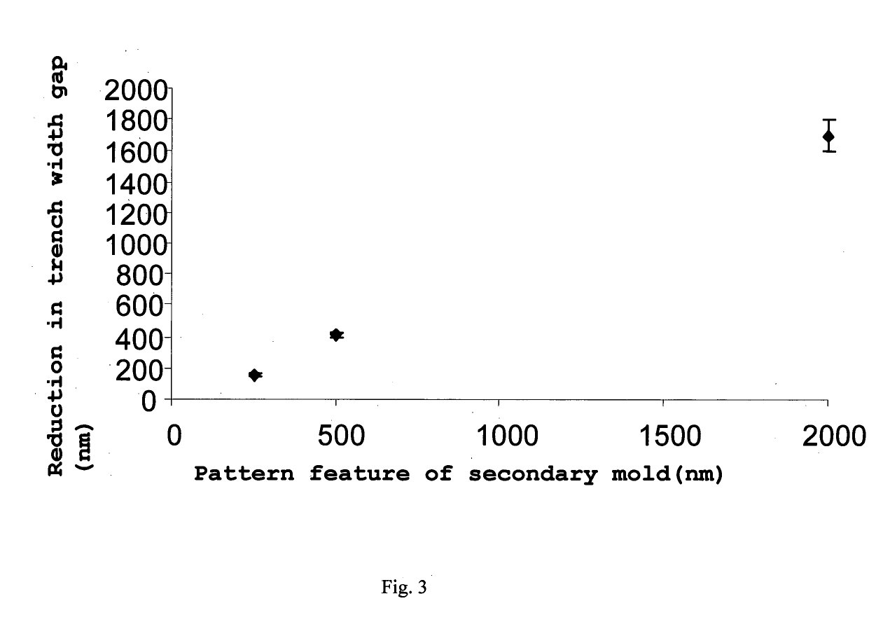

It can be observed in FIG. 3 that there is a greater reduction in the channel width of the primary imprint when a secondary mold having imprints of an increasingly smaller dimension are used.

### Example 3

The samples used in the current example were prepared using the same protocol as described in Example 1. The imprinting protocol was also the same as described in Example 1. This example further illustrates the use of a secondary imprint to reduce the pattern resolution on a PS primary structure.

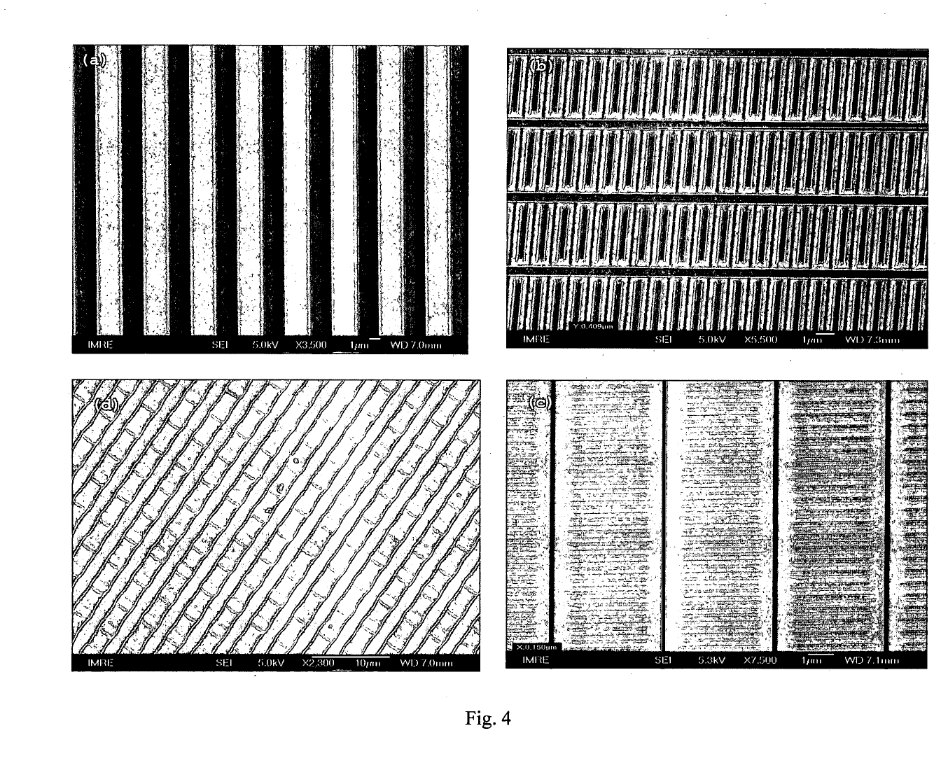

FIG. 4 shows a series of SEM images of the PS structure fabricated by the disclosed method, in which the effects of the pattern feature of the secondary molds on the trench width reduction of the primary structure are investigated.

FIG. 4(a) shows a SEM image, having a magnification of 3,500×, depicting grating patterns obtained by imprinting with a 2 μm grating primary mold. A trench width gap of 2 μm was observed for the primary PS structure. The trench gap width of 2 μm was congruent with the resolution pattern of the grating primary mold used.

FIG. 4(b) shows an SEM image having a magnification of 5,500×, depicting grating patterns obtained by imprinting with a 2 μm grating primary mold followed by a 500 nm grating secondary mold, applied 90° with respect to the primary imprint. A trench width gap reduction from 2 μm to 409 nm can be clearly observed in the primary imprint.

FIG. 4(c) shows an SEM image, having a magnification of 7,500×, depicting grating patterns obtained by imprinting first with a 2 μm grating primary mold followed by a 150 nm grating secondary mold, applied 90° with respect to the primary imprint. A trench width gap reduction from 2 μm to 150 nm can be observed.

FIG. 4(d) shows an SEM image, having a magnification of 2,300×, depicting grating patterns obtained by imprinting first with a 2 μm grating primary mold followed by a 2 μm grating secondary mold, applied 90° with respect to the primary imprint. A trench width gap reduction from 2 μm to 1.7 μm can be observed.

TABLE 3
Summary table of size of gaps fabricated by nanoimprint
lithography (NIL) for a PS polymer layer.

| | | | | | Percentage/ |
|---|---|---|---|---|---|
| Primary | Secondary | | Smallest | | fold |
| Imprint | Imprint | Polymer | Gap | | reduction |
| Mold | Mold | Material | size(nm) | Alignment | in gap size |
| 2 μm | 2 μm | PS | 1700 | 90° | 15% |
| gratings | gratings | | | | |
| 2 μm | 500 nm | PS | 409 | 90° | 79.6% |
| gratings | gratings | | | | (~4-5 times |
| | | | | | reduction) |
| 2 μm | 250 nm | PS | 150 | 90° | 92.5% |
| gratings | gratings | | | | (~13 times |
| | | | | | reduction) |
| 500 nm | 250 nm | PS | 263 | 90° | 47.4% |
| gratings | gratings | | | | (~2 times |
| | | | | | reduction) |
| 250 nm | 250 nm | PS | 200 | 90° | 20% |
| gratings | gratings | | | | (~1.7 times |
| | | | | | reduction) |

Table 3 provides a summary of trench width reduction for a PS primary structure, obtained through a series of primary and secondary mold imprinting in various alignments. It can be observed that for a PS primary structure, applying a secondary imprinting mold having 250 nm gratings in a 90° alignment is most effective for reducing the trench width of the primary PS structure. It can also be observed that when the resolution of the secondary mold is identical to that of the primary mold, very minimal size reduction was obtained.

### Applications

The methods disclosed herein offer a cheaper alternative to obtain nanopatterns using NIL because a mold with nanometer scale pattern is not required to achieve nanometer surface patterns. That is, the pressing by a mold having, a defined surface pattern against the surface of a primary imprint of a polymer structure, reduces the dimension of the primary imprint. For example, where the primary imprint is in the form of a channel, the width of the channel may be reduced to the nano-sized range from the micro-sized range.

Advantageously, the channel width of the primary imprint can be reduced to a range of about 2 to about 13 folds. Therefore, nano-sized polymer imprints can be achieved without the use of molds having imprints of sizes equivalent to the nano-sized polymer imprints. Therefore, a significant reduction of the channel width of the primary imprint can be achieved using the process disclosed herein.

Advantageously, different types of imprinted polymer structures having different channel widths can be produced using the methods disclosed herein. Furthermore, there is a significant reduction in the channel width of the primary imprint when the longitudinal axes of the primary and secondary imprints are substantially perpendicular or at an alignment angle of 45 degrees to each other.

Accordingly, the processes disclosed herein are able to fabricate templates having high-resolution patterns that can be used to deposit metal lines and wires for use as nanoelectrodes. Advantageously, the imprinted polymer structure can be used as a dry or wet shadow mask, to etch nanometer sized features into the substrate.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of making an imprint on a polymer structure comprising the step of (a) pressing a mold having a defined surface pattern against the surface of a primary imprint of a polymer structure to form a secondary imprint thereon, whereby said pressing step reduces the dimension of said primary imprint.

2. A method as claimed in claim 1 comprising the step of providing the secondary imprint having a smaller dimension than the primary imprint.

3. A method as claimed in claim 2 comprising the step of providing the primary imprint having a nano-sized or micro-sized dimension.

4. A method as claimed in claim 2, comprising the step of providing the secondary imprint having a nano-size dimension while the primary imprint has a micro-size dimension.

5. A method as claimed in claim 4, comprising the step of providing the secondary imprint in the nano-size range.

6. A method as claimed in claim 1, comprising the step of providing at least one of the primary and secondary imprints in the form of a generally longitudinal channel.

7. A method as claimed in claim 6, wherein the reduced dimension of the primary imprint reduces the width of the channel of said primary imprint.

8. A method as claimed in claim 7 wherein the width of the channel is reduced in the range of 2 to 13 fold.

9. A method as claimed in claim 7 wherein the channel width of said primary imprint is reduced from the micro-size range to the nano-size range after said width has been reduced by said pressing step.

10. A method as claimed in claim 9, wherein the channel width of said primary imprint is reduced from a size range of more than 1 micron to a size range of less than 800 nm after said pressing step.

11. A method as claimed in claim 1 wherein the polymer structure is comprised of a photoresist.

12. (canceled)

13. A method as claimed in claim 1 wherein the polymer structure is comprised of thermoplastic polymer.

14. (canceled)

15. A method as claimed in claim 1 wherein the pressing step (a) is performed at a temperature below the glass transition temperature of the polymer structure.

16. A method as claimed in claim 1, further comprising, prior to the pressing step (a), the step of (b) forming said primary imprint on said polymer structure by pressing a mold having a defined surface pattern against the surface of the polymer structure to form the primary imprint thereon.

17. A method as claimed in claim 15, wherein at least one of the pressing steps (a) and (b) are performed under at least one of the following conditions: (i) at a temperature condition in the range of 40° C. to 140° C., (ii) at a pressure condition in the range of 4 MPa to 6 MPa; and (iii) for a time condition in the range of 5 minutes to 10 minutes.

18. A method as claimed in claim 1, wherein the primary and secondary imprints are in the form of generally longitudinal channels, and wherein the pressing step (a) comprises the step of orienting the mold during the pressing step (a) such that the longitudinal axis of the primary and secondary imprints are at an alignment angle of 0 degrees to 90 degrees to each other.

19. A method as claimed in claim 18, wherein the alignment angle between the longitudinal axis of the primary and secondary imprints is 25 degrees to 60 degrees from each other.

20. A method as claimed in claim 1 further comprising, before said pressing step (a), the step of (c) spin-coating a polymer on a substrate to form the polymer structure.

21. A method as claimed in claim 20 wherein the substrate is chemically inert to said polymer.

22. (canceled)

23. A method of making an imprint on a polymer structure comprising the steps of:
(a) pressing a mold having a defined surface pattern against the surface of the polymer structure to form a primary imprint thereon; and
(b) pressing another mold having a defined surface pattern, against the surface of the primary imprint of the polymer structure to form a secondary imprint thereon, whereby the pressing step (b) reduces the dimension the primary imprint.

24-26. (canceled)
